(19) United States
(12) Patent Application Publication
(10) Pub. No.: US 2025/0338126 A1
(43) Pub. Date: Oct. 30, 2025

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Xin YOU, Dongguan (CN)

(73) Assignee: GUANGDONG OPPO MOBILE TELECOMMUNICATIONS CORP., LTD., Dongguan (CN)

(21) Appl. No.: 19/262,653

(22) Filed: Jul. 8, 2025

Related U.S. Application Data
(63) Continuation of application No. PCT/CN2023/071280, filed on Jan. 9, 2023.

(51) Int. Cl. H04W 12/106

(52) U.S. Cl. CPC H04W 12/106

(57) ABSTRACT

Provided are a wireless communication method and a communication device. The method includes: a first device sending a first message to a second device, wherein the first message is used for management and control related to first data, and the first message is associated with a data-type identifier of the first data.

### CROSS-REFERENCE TO RELATED APPLICATIONS

This application is a continuation of International Application No. PCT/CN2023/071280, filed on Jan. 9, 2023, the disclosure of which is hereby incorporated by reference in its entirety.

### TECHNICAL FIELD

This application relates to the field of communications technologies, and more specifically, to a wireless communication method and a communications device.

### RELATED ART

With continuous development of artificial intelligence (AI) and machine learning (ML) technologies, integration of communication technologies with the AI/ML technology is one of development trends of future communications technologies. Given that the AI/ML technology excels at leveraging and uncovering latent features of big data, communications systems may need to manage and control a large amount of different types of data, such as collecting a large amount of different types of data for learning by different AI models. Therefore, a method for distinguishing data types is urgently required to simplify complexity of performing related management or control on data.

### SUMMARY

This application provides a wireless communication method and a communications device. The following describes various aspects of this application.

According to a first aspect, a first device is provided, including a transceiver, a memory, and a processor, wherein the memory is configured to store a program, and the processor is configured to invoke the program in the memory and control the transceiver to receive or transmit a signal, to cause the first device to: transmit a first message to a second device, where the first message is used for management and control related to first data, and the first message is associated with a data type identity of the first data.

According to a second aspect, a second device is provided, including a transceiver, a memory, and a processor, wherein the memory is configured to store a program, and the processor is configured to invoke the program in the memory and control the transceiver to receive or transmit a signal, to cause the second device to: receive a first message transmitted by a first device, where the first message is used for management and control related to first data, and the first message is associated with a data type identity of the first data.

According to a third aspect, a wireless communication method is provided, including: transmitting, by a first device, a first message to a second device, where the first message is used for management and control related to first data, and the first message is associated with a data type identity of the first data.

### BRIEF DESCRIPTION OF DRAWINGS

FIG. 1 shows a wireless communications system 100 to which embodiments of this application are applied.

FIG. 2 is a schematic flowchart of a wireless communication method according to an embodiment of this application.

FIG. 3 is a schematic flowchart of a wireless communication method according to another embodiment of this application.

FIG. 4 is a schematic flowchart of a wireless communication method according to another embodiment of this application.

FIG. 5 is a schematic flowchart of a wireless communication method according to another embodiment of this application.

FIG. 6 is a schematic diagram of a communications device according to an embodiment of this application.

FIG. 7 is a schematic diagram of a communications device according to another embodiment of this application.

FIG. 8 is a schematic diagram of a communications device according to another embodiment of this application.

### DESCRIPTION OF EMBODIMENTS

Technical solutions in this application are described below with reference to the accompanying drawings.

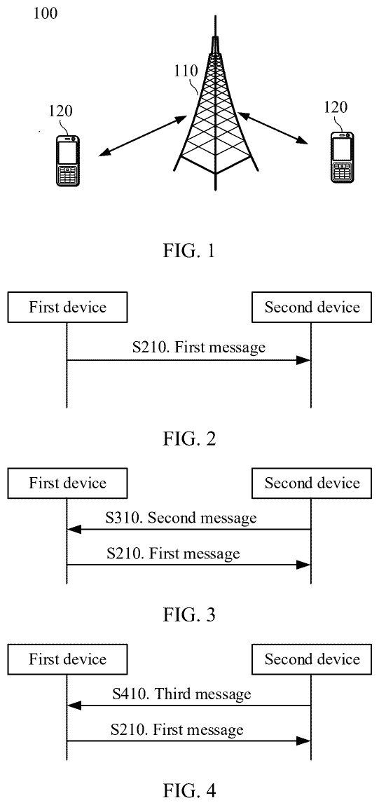

FIG. 1 shows a wireless communications system 100 to which embodiments of this application are applied. The wireless communications system 100 may include a network device 110 and a terminal device 120. The network device 110 may be a device that communicates with the terminal device 120. The network device 110 may provide communication coverage for a specific geographic area, and may communicate with the terminal device 120 within the coverage area.

FIG. 1 exemplarily shows one network device and two terminals. Optionally, the wireless communications system 100 may include a plurality of network devices, and another quantity of terminal devices may be included in coverage of each network device. This is not limited in embodiments of this application.

Optionally, the wireless communications system 100 may further include another network entity such as a network controller or a mobility management entity. This is not limited in embodiments of this application.

It should be understood that the technical solutions in embodiments of this application may be applied to various communications systems, such as a 5th generation (5G) system or a new radio (NR) system, a long term evolution (LTE) system, an LTE frequency division duplex (FDD) system, and an LTE time division duplex (TDD) system. The technical solutions provided in this application may further be applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, UE may function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device configured to communicate with the terminal device. In some implementations, the network device may be a core network device. For example, the core network device may be an access and mobility management function (AMF) network element, an authentication server function (AUSF) network element, a user plane function (UPF) network element, a session management function (SMF) network element, a location management function (LMF) network element, a policy control function (PCF) network element, or a unified data management (UDM) network element. In some embodiments of this application, the network device may be another core network device. This is not limited in embodiments of this application.

In some other implementations, the network device may also be referred to as an access network device or a radio access network device. For example, the network device may be a base station. The network device in embodiments of this application may be a radio access network (RAN) node (or device) that connects the terminal device to a wireless network. The base station may broadly cover the following various names, or may be replaced with the following names, such as a NodeB, an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (V2X), and machine-to-machine (M2M) communication, a network side device in a 6G network, a device that functions as a base station in a future communications system, or the like. The base station may support networks with a same access technology or different access technologies. A specific technology and a specific device form used by the network device are not limited in embodiments of this application.

The base station may be a fixed or mobile base station. For example, a helicopter or an unmanned aerial vehicle may be configured to act as a mobile base station, and one or more cells may move based on a location of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may also be implemented by software functions running on hardware, or by virtualization functions instantiated on a platform (for example, a cloud platform).

For ease of understanding, the following first describes an identity-based cell management process. Currently, a communications system introduces related cell identities to facilitate management and control of cell-related operations. In addition, definitions of cell identities vary for different usage scenarios.

In some scenarios, a physical cell identity (PCI) is introduced for a physical cell, and combination of a PCI and a frequency identity associated with a cell may form one complete physical cell identity. The physical cell identity may uniquely identify one cell in a local area, and the PCI may be reused between different geographical areas. Currently, the PCI may be used in scenarios such as measurement reporting and measurement configuration.

In some scenarios, a cell global identity (CGI) is introduced for a logical cell, and the CGI may include a public land mobile network (PLMN) ID and a cell ID (cell identity). Typically, the CGI is a globally unique identity. Currently, the CGI may be used in a scenario such as measurement reporting.

In some scenarios, an SCell index is introduced in a case that a serving cell is a secondary cell (SCell), to facilitate a terminal device to manage one or more secondary cells configured by a network device, such as SCell activation and deactivation.

With continuous development of AI and ML technologies, integration of communication technologies with the AI/ML technology is one of development trends of future communications technologies. Given that the AI/ML technology excels at leveraging and uncovering latent features of big data, communications systems may need to manage and control a large amount of different types of data, such as collecting a large amount of different types of data for learning of different AI/ML models. Therefore, a method for distinguishing data types is urgently required to simplify complexity of performing related management or control on data.

To resolve the foregoing problem, embodiments of this application provide a wireless communication method. In this method, a first device may perform a related operation (for example, management and control related to first data) on data (referred to as “first data” below) by using an associated data type identity in a first message, and identify the first data by using the data type identity, thereby facilitating identification on the first data, to simplify complexity of performing the related operation on the first data.

For ease of understanding, the following describes the wireless communication method according to embodiments of this application with reference to FIG. 2. FIG. 2 is a schematic flowchart of a wireless communication method according to an embodiment of this application. The method shown in FIG. 2 includes step S210.

In step S210, a first device transmits a first message to a second device.

The first message is used for management and control related to first data, and the first message is associated with a data type identity of the first data. The association between the first message and the data type identity of the first data may include that the first message carries the data type identity of the first data. Certainly, the association may alternatively include an association between information (for example, information about a data collection task described below) carried in the first message and the data type identity of the first data. In this case, the first message may not directly carry the data type identity of the first data. For details, refer to related descriptions of the following scenario 3. For brevity, details are not described herein.

A type of the data type identity is described. In some implementations, the data type identity of the first data may include one or more of the following: a globally unique data type identity; an area-defined data type identity; or a temporary data type identity.

In an example in which the data type identity of the first data includes the globally unique data type identity, in some implementations, for networks of a same communications system, a data type associated with the globally unique data type identity may be globally universal, or the globally unique data type identity may be used to uniquely identify data of a specific data type. For example, if a globally unique data type identity corresponding to data that includes a reference signal received power (RSRP) measurement quantity is an ID 1, the ID 1 represents the RSRP measurement quantity for any operators of the same communications system in the world.

In an example in which the data type identity of the first data is the area-defined data type identity, in some implementations, in an area corresponding to the area-defined data type identity, the area-defined data type identity may uniquely identify specific data.

In some scenarios, the area-defined data type identity may also be referred to as an operator-defined identity. In other words, the area-defined data type identity may be valid only for a specific operator, or the area-defined data type identity is used to identify data of a specific type in a communications network of a specific operator.

In embodiments of this application, a data type associated with the area-defined data type identity may generally be defined by an operator. Certainly, a manner of defining the area-defined data type identity is not limited in embodiments of this application.

In some scenarios, a range used by the globally unique data type identity and a range used by the area-defined data type identity may overlap. To avoid a conflict between the globally unique data type identity and the area-defined data type identity, the globally unique data type identity and the area-defined data type identity need to be distinguished.

In some implementations, a value range corresponding to the globally unique data type identity may be distinguished from a value range corresponding to the area-defined data type identity. In other words, a dedicated value range may be defined for the value range corresponding to the area-defined data type identity, and the value range of the globally unique data type identity does not overlap the dedicated value range. In some embodiments of this application, a dedicated value range may be defined for the value range corresponding to the globally unique data type identity. Correspondingly, the value range of the area-defined data type identity does not overlap the dedicated value range.

In an example in which the data type identity of the first data is the temporary data type identity, in some implementations, the temporary data type identity is used to uniquely identify data of a specific type in a specific communication process. For example, if a current serving cell of a terminal device associates data of a specific type with a temporary data type identity, the serving cell may manage and control, by using the temporary data type identity, the data of the specific type associated with the temporary data type identity. Once the terminal device leaves a connected state or is handed over to another cell, the temporary data type identity allocated to the serving cell previously becomes invalid.

A manner of configuring the temporary data type identity is not limited in embodiments of this application. In some implementations, the temporary data type identity may be dynamically allocated, for example, may be dynamically allocated by a network device.

In some implementations, the first data may be understood as data related to an AI model. For example, the first data may be data used for AI model training. For another example, the first data may be data used for AI model inference. For another example, the first data may be data used for AI model performance monitoring. In some embodiments of this application, the first data may be alternatively data associated with an ML model. This is not limited in embodiments of this application.

It may be learned from the foregoing descriptions that, after the first data is collected, the first data may be used for an AI model or an ML model. Therefore, in embodiments of this application, the first data may also be referred to as “to-be-collected first data” or “collected first data”. This is not limited in embodiments of this application.

It should be noted that the first data may be understood as data of one or more data types. This is not limited in embodiments of this application. In some implementations, if the first data includes data of a plurality of data types, the data type identity corresponding to the first data may include one or more data type identities. In some other implementations, if the first data includes data of one data type, the data type identity corresponding to the first data may include one or more data type identities.

In embodiments of this application, the first device and/or the second device are not limited. For example, the first device is a terminal device, and the second device is a network device. For another example, the first device is a network device, and the second device is a terminal device. For another example, both the first device and the second device are network devices. For another example, both the first device and the second device are terminal devices. The network device may be a core network device or an access network device. For details, refer to the foregoing descriptions.

The following describes a manner of defining the data type identity provided in embodiments of this application. In some implementations, the data type identity of the first data may be associated with data feature information of the first data.

In embodiments of this application, associating the data feature information with the data type identity simplifies a process for a data demander (or a data requester) to obtain a data label. For example, a data label may be determined based on a data type identity, which is conducive to an AI/ML learning process that requires a data label, for example, supervised learning.

In addition, indicating the first data based on the data type identity simplifies a process for a data requester and/or a data acquirer to learn about the first data, so as to select different data collection policies subsequently based on different data type identities. For example, a data filtering policy may be executed to filter out, from collected data, those data associated with a data type identity that does not meet a data filtering policy requirement. For another example, a data selection policy may be executed to select, from collected data, those data associated with a data type identity that meets a data selection policy requirement. For another example, a data deletion policy may be executed to delete, from collected data, those data associated with a data type identity that meets a data deletion policy requirement. For another example, a data extraction policy may be executed to extract, from collected data, those data associated with a data type identity that meets a data extraction policy requirement.

That the data type identity of the first data is associated with the data feature information of the first data may be understood as that an association relationship exists between the data type identity of the first data and the data feature information of the first data, or a correspondence exists between the data type identity of the first data and the data feature information of the first data.

It should be noted that, in embodiments of this application, a manner of obtaining the foregoing association relationship is not limited. In some implementations, the foregoing association relationship may be predefined, for example, may be predefined in a protocol or may be provided in a default manner. In some other implementations, the foregoing association relationship may be preconfigured.

The data feature information of the first data is used to indicate a data feature of the first data. In some implementations, the data feature information of the first data includes one or more of the following: a data meaning of the first data; a data source of the first data; or data precision of the first data.

In some implementations, the data meaning of the first data is used to indicate an actual meaning of the first data. Therefore, a manner of defining the data type identity based on the data meaning of the first data may be referred to as “a meaning definition of the first data”.

For example, assuming that the first data includes location information, correspondingly, a data type label defined based on the data meaning of the first data is used to indicate a location of a positioned object.

For another example, assuming that the first data includes an RSRP measurement result of a cell, correspondingly, a data type label defined based on the data meaning of the first data is used to indicate an RSRP measurement result of a measured cell.

In embodiments of this application, defining the data type identity of the first data based on the data meaning of the first data simplifies a process for a data requester to obtain the data meaning.

In some implementations, the source of the first data is used to indicate one or more of the following: a country to which the first data belongs; a geographical area to which the first data belongs; an operator to which the first data belongs; a cell to which the first data belongs; a tracking area to which the first data belongs; or an access network area to which the first data belongs.

In an example in which the source of the first data includes the country to which the first data belongs, in some implementations, the country to which the first data belongs may include a country generating the first data. In some other implementations, the country to which the first data belongs may include a country using the first data. In some embodiments of this application, the country to which the first data belongs may alternatively include a country generating the first data and using the first data. This is not limited in embodiments of this application.

It should be noted that the source of the first data may be indicated based on a country identity of the country to which the first data belongs (for example, a country name or a country symbol), or the source of the first data may be indicated based on a geographical location of the country to which the first data belongs. This is not limited in embodiments of this application.

In an example in which the source of the first data includes the geographical area to which the first data belongs, in some implementations, the geographical area to which the first data belongs may include a geographical area generating the first data. In some other implementations, the geographical area to which the first data belongs may include a geographical area using the first data. In some embodiments of this application, the geographical area to which the first data belongs may alternatively include a geographical area generating the first data and using the first data. This is not limited in embodiments of this application.

It should be noted that the source of the first data may be indicated based on a geographical area identity of the geographical area to which the first data belongs, or the source of the first data may be indicated based on a geographical location of the geographical area to which the first data belongs. This is not limited in embodiments of this application.

The geographical area identity is not limited in embodiments of this application. For example, the geographical area identity may include identities of one or more countries in a geographical area. For another example, the geographical area identity may include identities of one or more provinces in a geographical area. For another example, the geographical area identity may include identities of one or more cities in a geographical area.

In addition, the geographical location of the geographical area is not limited in embodiments of this application. For example, the geographical location of the geographical area may include at least one of longitude, latitude, or altitude information of the geographical area.

In an example in which the source of the first data includes the operator to which the first data belongs, in some implementations, the operator to which the first data belongs may include an operator generating the first data. In some other implementations, the operator to which the first data belongs may include an operator using the first data. In some embodiments of this application, the operator to which the first data belongs may alternatively include an operator generating the first data and using the first data. This is not limited in embodiments of this application.

It should be noted that the source of the first data may be indicated based on an operator identity of the operator to which the first data belongs, or the source of the first data may be indicated based on a geographical location of the operator to which the first data belongs. This is not limited in embodiments of this application.

The operator identity is not limited in embodiments of this application. For example, the operator identity may be represented by one or more of the following: at least one of PLMN identity information, stand-alone non-public network (SNPN) identity information, or closed subscriber group (CAG) identity information.

The foregoing describes the solution of indicating the source of the first data with reference to a physical area (for example, an operator, a geographical area, or a country) to which the first data belongs, and the following describes a solution of indicating the source of the first data with reference to a logical area to which the first data belongs.

In some implementations, the logical area may include one or more of the cell to which the first data belongs, the tracking area to which the first data belongs, or the access network area to which the first data belongs. Embodiments of this application set no limitation on the logical area. For example, the logical area may alternatively include a PLMN.

In some implementations, the logical area to which the first data belongs may include a logical area generating the first data. In some other implementations, the logical area to which the first data belongs may include a logical area using the first data. In some embodiments of this application, the logical area to which the first data belongs may alternatively include a logical area generating the first data and using the first data. This is not limited in embodiments of this application.

In an example in which the logical area includes a cell, the source of the first data may include the cell to which the first data belongs. In some implementations, the source of the first data may be indicated by a cell identity of the cell to which the first data belongs. The cell identity is not specifically limited in embodiments of this application. For example, cell identity information may include a PCI. For another example, cell identity information may include a PCI and cell frequency information. For another example, cell identity information may include a CGI. For another example, cell identity information may include a serving cell index.

In an example in which the logical area includes a tracking area, the source of the first data may include the tracking area to which the first data belongs. In some implementations, the source of the first data may be indicated by an identity of the tracking area to which the first data belongs. The identity of the tracking area is not specifically limited in embodiments of this application. For example, the identity of the tracking area may include a TAC.

In an example in which the logical area includes an access network area, the source of the first data may include the access network area to which the first data belongs. In some implementations, the source of the first data may be indicated by an identity of the access network area to which the first data belongs. The identity of the access network area is not specifically limited in embodiments of this application. For example, the identity of the access network area may include an access network area code (RAN area code, RANAC).

In embodiments of this application, defining a data type of the first data based on the source of the first data facilitates a data requester to obtain the data source quickly.

In some implementations, the data precision of the first data is used to indicate reliability of the first data. In embodiments of this application, a manner of indicating the data precision of the first data is not limited. For example, the precision of the first data may be indicated by a precision level of the precision of the first data. For another example, the precision of the first data may be indicated by a precision range of the precision of the first data. For another example, the precision of the first data may be indicated by a precision value of the precision of the first data.

In embodiments of this application, determining the data type identity of the first data based on the precision of the first data simplifies a process for a data requester and/or a data acquirer to obtain the precision of the first data, so that different data collection policies are subsequently selected based on different precision types. For example, a data filtering policy may be executed to filter out data with relatively low precision in collected data. For another example, a data selection policy may be executed to select data whose precision meets a selection condition in collected data. For another example, a data deletion policy may be executed to delete data whose precision does not meet a selection condition in collected data. For another example, a data extraction policy may be executed to extract data whose precision meets a selection condition in collected data.

The foregoing describes the manner of defining the data type identity in embodiments of this application. With reference to implementations 1 and 2, the following describes a manner of carrying the data type identity in the first message in embodiments of this application.

In implementation 1, the data type identity of the first data may be carried in one indicator field in the first message. In other words, the data type identity of the first data is carried in a first indicator field in the first message.

As described above, the data type identity of the first data may be associated with one or more of the data feature information of the first data. Correspondingly, the first indicator field is used to carry the data type identity of the first data. Therefore, it may be understood that the first indicator field is associated with one or more types of the data feature information of the first data, or information carried in the first indicator field is used to indicate one or more of the data feature information of the first data.

It should be noted that in embodiments of this application, a quantity of bits included in the first indicator field is not limited. For example, the first indicator field may include one bit. In some embodiments of this application, the first indicator field may include a plurality of bits.

It is assumed that the data type identity of the first data is associated with one type of data feature information of the first data, and the data feature information of the first data is the data meaning of the first data. As described above, there is an association relationship between the data type identity of the first data carried in the first indicator field and the data meaning of the first data. For example, when the data type identity of the first data carried in the first indicator field is “00000001”, it may indicate that the data meaning of the first data is an RSRP measurement result. For another example, when the data type identity of the first data carried in the first indicator field is “00000010”, it may indicate that the data meaning of the first data is a reference signal received quality (RSRQ) measurement result. For another example, when the data type identity of the first data carried in the first indicator field is “00000011”, it may indicate that the data meaning of the first data is a signal to interference plus noise ratio (SINR) measurement result. For another example, when the data type identity of the first data carried in the first indicator field is “00000100”, it may indicate that the data meaning of the first data is location information.

As described above, in some implementations, the data type identity of the first data carried in the first indicator field may be associated with a plurality of types of data feature information of the first data. In this case, it may be understood that the first indicator field may be associated with a plurality of types of data feature information. In some implementations, when the first indicator field is associated with the plurality of types of data feature information of the first data, the plurality of types of data feature information may include the data meaning of the first data, thereby simplifying a process of obtaining the data meaning of the first data. In some embodiments of this application, the plurality of types of data feature information may alternatively not include the data meaning of the first data.

For example, when the data type identity of the first data is associated with the data meaning of the first data and the source information of the first data, the first indicator field may be associated with the data meaning of the first data and the source of the first data.

For another example, when the data type identity of the first data is associated with the data meaning of the first data and the precision information of the first data, the first indicator field may be associated with the data meaning of the first data and the precision of the first data.

For another example, when the data type identity of the first data is associated with the data source of the first data and the precision information of the first data, the first indicator field may be associated with the data source of the first data and the precision of the first data.

For another example, when the data type identity of the first data is associated with the data meaning of the first data, the precision of the first data, and the source information of the first data, the first indicator field may be associated with the data meaning of the first data, the precision of the first data, and the source of the first data.

In implementation 2, the data type identity of the first data may be carried in a plurality of indicator fields in the first message. In other words, the data type identity of the first data is carried in the plurality of indicator fields in the first message, where the plurality of indicator fields may include a first indicator field and at least one second indicator field.

As described above, the data type identity of the first data may be associated with a plurality of types of data feature information of the first data, and the plurality of indicator fields are used to carry the data type identity of the first data. Therefore, in embodiments of this application, the plurality of indicator fields are associated with the plurality of types of data feature information, or the plurality of types of data feature information may be carried in the plurality of indicator fields.

It should be noted that, in embodiments of this application, data feature information associated with different indicator fields in the plurality of indicator fields may be different. In some embodiments of this application, data feature information associated with some or all of the plurality of indicator fields may be the same or partially the same.

In addition, in some scenarios, an indicator field carrying the data feature information associated with the data type identity of the first data may also be referred to as an information field of the data type identity of the first data. For ease of description, the following uses the indicator field as an example for description.

In embodiments of this application, a manner of carrying a plurality of pieces of data feature information in the plurality of indicator fields is not limited. The following provides description with reference to implementation 2-1, implementation 2-2, and implementation 2-3.

In implementation 2-1, each of the plurality of indicator fields may carry one type of data feature information. Correspondingly, data feature information carried in all of the plurality of indicator fields may be different to each other, or in other words, the plurality of indicator fields are in a one-to-one correspondence with the plurality of pieces of data feature information. In some embodiments of this application, data features carried in some of the plurality of indicator fields may be the same.

For example, as shown in Table 1, the data type identity of the first data may be associated with the data meaning of the first data, the source of the first data, and the precision of the first data. The plurality of indicator fields may include an indicator field 1, an indicator field 2, and an indicator field 3. Correspondingly, the indicator field 1 may be associated with the data meaning of the first data, the indicator field 2 may be associated with the source of the first data, and the indicator field 3 may be associated with the precision of the first data.

TABLE 1

| Indicator field 1 | Indicator field 2 | Indicator field 3 |
|---|---|---|
| Data meaning of the first | Source of the first | Precision of the first |
| data | data | data |

In implementation 2-2, one indicator field in the plurality of indicator fields may be associated with one type of data feature information, and other indicator fields in the plurality of indicator fields may be associated with a plurality of types of data feature information.

For example, as shown in Table 2, the data type identity of the first data may be associated with the data meaning of the first data, the source of the first data, and the precision of the first data. The plurality of indicator fields may include an indicator field 1 and an indicator field 2. Correspondingly, the indicator field 1 may be associated with the data meaning of the first data, and the indicator field 2 may be associated with the source of the first data and precision of the first data.

TABLE 2

| Indicator field 1 | Indicator field 2 |
|---|---|
| Data meaning of the first | Source of the first data and data precision of |
| data | the first data |

In implementation 2-3, each of the plurality of indicator fields may be associated with a plurality of types of data feature information.

For example, as shown in Table 3, the data type identity of the first data may be associated with the data meaning of the first data, a source 1 of the first data, a source 2 of the first data, and the precision of the first data. The plurality of indicator fields may include an indicator field 1 and an indicator field 2. Correspondingly, the indicator field 1 may be associated with the data meaning of the first data and the source 1 of the first data, and the indicator field 2 may be associated with the source 2 of the first data and the precision of the first data.

TABLE 3

| Indicator field 1 | Indicator field 2 |
|---|---|
| Data meaning of the first data and | Source 2 of the first data and data |
| source 1 of the first data | precision of the first data |

It should be noted that in embodiments of this application, quantities of bits included in the plurality of indicator fields are not limited. For example, an indicator field in the plurality of indicator fields may include one bit. In some embodiments of this application, an indicator field in the plurality of indicator fields may include a plurality of bits.

In addition, in embodiments of this application, quantities of bits included in the plurality of indicator fields may be the same. In some embodiments of this application, quantities of bits included in the plurality of indicator fields may alternatively be different to each other. For example, quantities of bits included in all of the plurality of indicator fields may be different to each other. For another example, quantities of bits included in some of the plurality of indicator fields may be different to each other.

In embodiments of this application, the information included in the foregoing Table 1 to Table 3 may also be used as several implementations of defining the data type identity, and the data type identity is defined in a manner predefined in a protocol, a default manner, or a preconfigured manner.

The foregoing describes the data type identity provided in embodiments of this application. The following describes several application scenarios of the data type identity with reference to scenarios 1 to 4. In embodiments of this application, a related process (for example, scenarios described below) of data collection is controlled based on the data type identity, so that data collection and management processes of different data types can be similar, that is, data may be collected and/or managed based on corresponding data type identities, facilitating standardization of data collection and management processes.

It should be noted that the data type identity in embodiments of this application may be further applied to other scenarios. This is not specifically limited in embodiments of this application. In addition, the scenarios described in embodiments of this application may be used separately or used in combination. This is not limited in embodiments of this application. In addition, for the data type identity in the scenarios described in embodiments of this application, refer to the foregoing descriptions. Certainly, the data type identity in the scenarios described below may be defined in another manner. This is not limited in embodiments of this application.

### Scenario 1: Establish an Association Relationship Between a Plurality of Type Identities.

As described above, a data type identity of data may include a plurality of type identities. Taking the first data as an example, the plurality of type identities may include at least two of a globally unique data type identity of the first data; an area-defined data type identity of the first data; or a temporary data type identity of the first data.

Because the plurality of type identities are used to identify the first data, there may be an association relationship between the plurality of type identities. Correspondingly, in embodiments of this application, the association relationship between the plurality of type identities may be established by using the first message. In other words, the first message is used to indicate the association relationship between the plurality of type identities.

A type of the foregoing association relationship is not limited in embodiments of this application. For example, the foregoing association relationship may be a one-to-one association relationship between the plurality of type identities. For another example, the foregoing association relationship may be a many-to-one association relationship between the plurality of type identities. For another example, the foregoing association relationship may be a one-to-many association relationship between the plurality of type identities.

It should be noted that, in embodiments of this application, the type of the foregoing association relationship may be indicated by the first message, or may be predefined, defined in a default manner, or preconfigured. This is not limited in embodiments of this application.

In addition, in embodiments of this application, a quantity of the plurality of type identities included in the first message is not limited. In other words, the first message may include two or more of the following plurality of type identities: at least one globally unique data type identity; at least one area-defined data type identity; or at least one temporary data type identity.

In some implementations, the first message may carry the foregoing plurality of type identities, to indicate that there is an association relationship between the plurality of type identities.

For example, the first message may carry a globally unique data type identity 1 and an area-defined data type identity 1. In this case, the first message indicates that there is an association relationship between the globally unique data type identity 1 and the area-defined data type identity 1.

For another example, the first message may carry a globally unique data type identity 1 and a temporary data type identity 2. In this case, there is an association relationship between the globally unique data type identity 1 and the temporary data type identity 2.

For another example, the first message may carry an area-defined data type identity 2 and a temporary data type identity 3. In this case, there is an association relationship between the area-defined data type identity 2 and the temporary data type identity 3.

For another example, the first message may carry a globally unique data type identity 1, an area-defined data type identity 2, and a temporary data type identity 3. In this case, there is an association relationship among the globally unique data type identity 1, the area-defined data type identity 2, and the temporary data type identity 3.

In embodiments of this application, a manner of triggering the first message is not limited. For example, as shown in FIG. 3, the first message may be requested by the second device to the first device by using a second message, or in other words the first message may be triggered after the first device receives a second message (in this case, the second message is not necessarily specifically used to request the foregoing association relationship). In other words, before step S210, the foregoing method further includes step S310: the second device transmits a second message to the first device, where the second message is used to request the foregoing association relationship or is used to trigger transmission of the first message. Correspondingly, the foregoing step S210 includes: the first device transmits the first message to the second device in response to the second message (in this case, the first message may also be referred to as a response message). In some embodiments of this application, the first message may be actively transmitted by the first device to the second device. In this case, the second device does not need to request the first device, or in other words, the second device does not need to transmit the second message to the first device.

In addition, a trigger condition for actively triggering the first message by the first device is not limited in embodiments of this application. In some implementations, the trigger condition may include: the first device updates the association relationship between the plurality of type identities of the first data. In some embodiments of this application, the trigger condition may include: the first device establishes the association relationship between the plurality of type identities of the first data after or before obtaining the first data.

Generally, a quantity of data types to be identified by the globally unique data type identity is greater than a quantity of data types to be identified by another data type identity (the area-defined data type identity and/or the temporary data type identity). Therefore, a quantity of bits occupied by the globally unique data type identity is greater than a quantity of bits occupied by the another data type identity. This means that overheads required for transmitting the globally unique data type identity are greater than overheads required for transmitting the another data type identity. In embodiments of this application, the association relationship between the plurality of type identities is indicated to the second device by using the first message. In this way, associated data may be subsequently indicated between the first device and the second device based on the another data type identity, instead of using the globally unique data type identity, thereby reducing overheads for transmitting the data type identity.

In addition, in embodiments of this application, because the temporary data type identity may be dynamically allocated, by establishing an association relationship between the temporary data type identity and another data type identity (for example, the globally unique data type identity and/or the area-defined data type identity), a device other than the first device and the second device can be prevented from obtaining a data type based on the another data type identity, thereby improving a data confidentiality level.

### Scenario 2: Scenario of Querying a Data Transmission State.

In some scenarios, the second device expects to obtain the first data. In this case, the first device may notify the second device of a transmission state of the first data by using the first message, so that the second device can determine, based on the first message, whether to obtain the first data.

In some implementations, the first data may be of a data type that the first device is concerned with. The first data being of the data type that the first device is concerned with may include that the first device is concerned with the first data and the first device can provide the first data, and/or the first data being of the data type that the first device is concerned with may include that the first device is concerned with the first data but the first device cannot provide the first data.

In embodiments of this application, a cause for which the first device cannot provide the first data is not limited. For example, the foregoing cause may include that the first device does not support collection of the first data. For another example, the foregoing cause may include that the first device supports collection of the first data and a current data volume of the first data is 0. For another example, the foregoing cause may include that the first device supports collection of the first data and a current data volume of the first data is less than a preset data volume. For another example, the foregoing cause may include that the first device supports collection of the first data and a current data volume of the first data is less than a data volume required by a data requester (for example, the second device). For another example, the foregoing cause may include that the first data does not meet an associated restriction condition or meets an associated restriction condition. The restriction condition will be described later. For brevity, details are not described herein. In some embodiments of this application, the foregoing causes may be used in combination or used separately. This is not limited in embodiments of this application.

In some implementations, the transmission state of the first data (or the first message) may include one or more of the following: data type identity information associated with data providable by the first device; data volume information associated with data providable by the first device; precision information associated with data providable by the first device; data source information associated with data providable by the first device; data type identity information associated with data that is not providable by the first device; cause indication information associated with data that is not providable by the first device; or restriction condition information associated with data that is not providable by the first device.

In an example in which the first message includes the data type identity information associated with the data providable by the first device, the data type identity information associated with the data providable by the first device may include the data type identity of the first data, for example, a globally unique data type identity of the first data.

It should be noted that in embodiments of this application, the data providable by the first device may include one or more data types. This is not limited in embodiments of this application.

In addition, in embodiments of this application, the data providable by the first device may be represented by using a data type identity list. In other words, the data type identity list may include data type identities respectively corresponding to data types providable by the first device.

In an example in which the first message includes the data volume information associated with the data providable by the first device, the data volume information associated with the data providable by the first device may include a data volume of the first data, for example, a data volume of the first data currently stored by the first device.

In an example in which the first message includes the precision information associated with the data providable by the first device, the precision information associated with the data providable by the first device may include precision of the first data, for example, a precision level of precision of the first data currently stored by the first device.

In an example in which the first message includes the data source information associated with the data providable by the first device, the data source information associated with the data providable by the first device may include data source information of the first data, for example, operator information of a source of the first data currently stored by the first device.

In an example in which the first message includes the data type identity information associated with the data that is not providable by the first device, the data type identity information associated with the data that is not providable by the first device may include the data type identity of the first data, for example, a temporary data type identity of the first data.

It should be noted that in embodiments of this application, the data that is not providable by the first device may include one or more data types. This is not limited in embodiments of this application.

In addition, in embodiments of this application, a data type of the data that is not providable by the first device may be represented by a data type identity list. In other words, the data type identity list may include data type identities respectively corresponding to data types that is not providable by the first device.

In an example in which the first message includes the cause indication information associated with the data that is not providable by the first device, for a cause associated with the data that is not providable by the first device, refer to the foregoing descriptions. For brevity, details are not described herein again.

In embodiments of this application, a specific form of the foregoing indication information is not limited. For example, the foregoing indication information may include a cause value, and different cause values may correspond to different causes. In some embodiments of this application, a cause may be indicated in another manner.

In an example in which the first message includes the restriction condition information associated with the data that is not providable by the first device, a restriction condition is used to indicate a condition under which the first device can provide the the above unprovidable data, or in other words, in a case that a restriction condition is met, the first device can provide the above unprovidable data. In some embodiments of this application, the foregoing restriction condition is used to indicate a condition for the data that is not providable by the first device, or in a case that the restriction condition is met, the first device cannot provide data.

In some implementations, the restriction condition information includes one or more of the following information: first time information, second time information, first logical area information, or second logical area information.

In an example in which the restriction condition includes the first time information, in some implementations, data associated with the first time information is providable outside a range constrained by the first time information. In some other implementations, data associated with the first time information is providable within a range constrained by the first time information.

In an example in which the restriction condition includes the second time information, in some implementations, data associated with the second time information is not providable outside a range constrained by the second time information. In some other implementations, data associated with the second time information in unprovidable within a range constrained by the second time information.

In an example in which the restriction condition includes the first logical area information, in some implementations, data associated with the first logical area information is providable outside a range constrained by the first logical area information. In some other implementations, data associated with the first logical area information is providable within a range constrained by the first logical area information.

The first logical area information may be used to indicate a first logical area, and the first logical area may be, for example, one or more of a PLMN, a cell, a tracking area, or an access network area. This is not limited in embodiments of this application. Correspondingly, the first logical area information may include one or more of PLMN identity information, an identity of a cell, an identity of a tracking area, or an identity of an access network area. For the identity of the cell, the identity of the tracking area, and the identity of the access network area, refer to the foregoing descriptions. For brevity, details are not described herein again.

In an example in which the restriction condition includes the second logical area information, in some implementations, data associated with the second logical area information is not providable outside a range constrained by the second logical area information. In some other implementations, data associated with the second logical area information is not providable within a range constrained by the second logical area information.

The second logical area information may be used to indicate a second logical area, and the second logical area may be, for example, one or more of a PLMN, a cell, a tracking area, or an access network area. This is not limited in embodiments of this application. Correspondingly, the second logical area information may include one or more of PLMN identity information, an identity of a cell, an identity of a tracking area, or an identity of an access network area. For the identity of the cell, the identity of the tracking area, and the identity of the access network area, refer to the foregoing descriptions. For brevity, details are not described herein again.

In embodiments of this application, a manner of triggering the first message is not limited. For example, in some scenarios, the second device expects to obtain data of a specific data type from the first device, but the second device does not know specific data types of data that the first device can provide. In this case, the second device may request or query the first device by using a third message. As shown in FIG. 4, the first message may be triggered after the second device requests or queries the first device by using the third message. In other words, before step S210, the foregoing method further includes step S410: the second device transmits a third message to the first device, where the third message is used to request to query the transmission state of the first data. Correspondingly, the foregoing step S210 includes: the first device transmits the first message to the second device in response to the third message (in this case, the first message may also be referred to as a response message). In some embodiments of this application, the first message may be actively transmitted by the first device to the second device. In this case, the second device does not need to request the first device, or in other words the second device does not need to transmit the third message to the first device.

In some implementations, the third message includes one or more of the following information: data type identity information associated with the first data; data volume requirement information associated with the first data; data source requirement information associated with the first data; or precision requirement information associated with the first data.

The data volume requirement information of the first data may be understood as being used to indicate a data volume requirement requested by a data requester. In embodiments of this application, the data volume requirement information associated with the first data may be predefined, preconfigured, or indicated by the data requester. This is not limited in embodiments of this application.

The data source requirement information of the first data may be understood as being used to indicate a data source requested by a data requester. In embodiments of this application, the data source information associated with the first data may be predefined, preconfigured, or indicated by the data requester. This is not limited in embodiments of this application.

The precision requirement information of the first data may be understood as being used to indicate precision requirement information requested by a data requester. In embodiments of this application, the precision requirement information associated with the first data may be predefined, preconfigured, or indicated by the data requester. This is not limited in embodiments of this application.

It should be noted that, in embodiments of this application, a data type of data associated with the first message and a data type of data associated with the third message may be different or the same. This is not limited in embodiments of this application.

### Scenario 3: Scenario of Managing a Data Collection Task.

In some scenarios, the second device may collect the first data by executing a data collection task. In this case, it may be understood that the data collection task is associated with the data type identity of the first data. Correspondingly, the first device may manage the data collection task by transmitting the first message to the second device. In other words, the first message is used to execute a data collection task management operation.

In some implementations, the data collection task management operation includes one or more of the following operations: adding a data collection task; deleting a data collection task; modifying a data collection task; suspending a data collection task; or resuming a data collection task.

It should be noted that if the data collection task management operation executed via the first message includes a plurality of operation types, the plurality of operation types may apply to data of a same data type or data of different data types. This is not limited in embodiments of this application.

In an example in which the data collection task management operation includes adding a data collection task, the first message is used by the second device to execute adding of the data collection task, or in other words, the first message is used to instruct the second device to add the data collection task.

In some implementations, the first message may include a task identity of the data collection task and one or more data type identities associated with the data collection task. For example, if the added data collection task indicated by the first message is used to collect the first data, the first message may carry the task identity of the data collection task and the data type identity of the first data. In some embodiments of this application, if there is an association relationship between the task identity of the data collection task and the data type identity, the first message may include only the task identity of the data collection task. Correspondingly, the second device may determine, based on the task identity of the data collection task and the association relationship between the task identity and the data type identity, the data type identity associated with the task identity of the data collection task, so as to determine a type of data to be collected by the data collection task.

It should be noted that the association relationship between the task identity of the data collection task and the data type identity may be preset, predefined, or configured by a network device. This is not limited in embodiments of this application.

In addition, in embodiments of this application, a type of the foregoing association relationship is not limited. For example, the association relationship between the task identity of the data collection task and the data type identity may include a one-to-many association relationship. For another example, the association relationship between the task identity of the data collection task and the data type identity may include a one-to-one association relationship. For another example, the association relationship between the task identity of the data collection task and the data type identity may include a many-to-one association relationship.

In an example in which the data collection task management operation includes deleting a data collection task, the first message is used by the second device to execute deletion of the data collection task, or in other words the first message is used to instruct the second device to delete the data collection task.

In some implementations, the first message may include a task identity of the data collection task and one or more data type identities associated with the data collection task. For example, if the deleted data collection task indicated by the first message is used to collect the first data, the first message may carry the task identity of the data collection task and the data type identity of the first data. In some embodiments of this application, the first message may alternatively include only the task identity of the data collection task.

In an example in which the data collection task management operation includes modifying a data collection task, the first message is used by the second device to execute modification of the data collection task, or in other words, the first message is used to instruct the second device to modify the data collection task.

Content of the modification of the data collection task is not limited in embodiments of this application. For example, modifying a data collection task may include adding one or more data types associated with the data collection task. For another example, modifying a data collection task may include deleting one or more data types associated with the data collection task. For another example, modifying a data collection task may include replacing one or more data types associated with the data collection task. For ease of description, the deleted one or more data types, the added one or more data types, and the replaced one or more data types are collectively referred to as modified data types.

In some implementations, the first message may include a task identity of the modified data collection task and one or more data type identities associated with the modified data collection task. For example, if the first message indicates to modify a first data type (that is, the foregoing modified data type) associated with a data collection task, the first message may carry a task identity of the data collection task and a data type identity of the first data type.

It should be noted that the one or more data type identities associated with the modified data collection task may be understood as that an association relationship exists between the modified data collection task and the modified data type. In embodiments of this application, a type of the foregoing association relationship is not limited. For example, the association relationship between the task identity of the modified data collection task and the modified data type identity may include a one-to-many association relationship. For another example, the association relationship between the task identity of the modified data collection task and the modified data type identity may include a one-to-one association relationship. For another example, the association relationship between the task identity of the modified data collection task and the modified data type identity may include a many-to-one association relationship.

In an example in which the data collection task management operation includes suspending a data collection task, the first message is used by the second device to execute suspension of the data collection task, or in other words, the first message is used to instruct the second device to suspend the data collection task.

In some implementations, the first message may include a task identity of the suspended data collection task and one or more data type identities associated with the data collection task. For example, if the suspended data collection task indicated by the first message is used to collect the first data, the first message may carry the task identity of the suspended data collection task and the data type identity of the first data. In some embodiments of this application, the first message may include only the task identity of the suspended data collection task.

It should be noted that the one or more data type identities associated with the suspended data collection task may be understood as that an association relationship exists between the suspended data collection task and a suspended data type. In embodiments of this application, a type of the foregoing association relationship is not limited. For example, the association relationship between the task identity of the data collection task and the data type identity may include a one-to-many association relationship. For another example, the association relationship between the task identity of the data collection task and the data type identity may include a one-to-one association relationship. For another example, the association relationship between the task identity of the data collection task and the data type identity may include a many-to-one association relationship.

In an example in which the data collection task management operation includes resuming a data collection task, the first message is used by the second device to execute resumption of the data collection task, or in other words, the first message is used to instruct the second device to resume the data collection task.

In embodiments of this application, a scenario of resuming a data collection task is not specifically limited. For example, the data collection task may be resumed after the data collection task is suspended. In other words, a suspended data collection task may be resumed by the first message.

In some implementations, the first message may include a task identity of the resumed data collection task and one or more data type identities associated with the data collection task. For example, if the resumed data collection task indicated by the first message is used to collect the first data, the first message may carry the task identity of the resumed data collection task and the data type identity of the first data. In some embodiments of this application, the first message may include only the task identity of the resumed data collection task.

It should be noted that the one or more data type identities associated with the resumed data collection task may be understood as that an association relationship exists between the resumed data collection task and a resumed data type. In embodiments of this application, a type of the foregoing association relationship is not limited. For example, the association relationship between the task identity of the data collection task and the data type identity may include a one-to-many association relationship. For another example, the association relationship between the task identity of the data collection task and the data type identity may include a one-to-one association relationship. For another example, the association relationship between the task identity of the data collection task and the data type identity may include a many-to-one association relationship.

As described above, in some scenarios, the data collection task management operation includes a plurality of operation types, such as adding a data collection task, deleting a data collection task, modifying a data collection task, suspending a data collection task, and resuming a data collection task. Correspondingly, one first message may be used to indicate at least two of the foregoing operation types, or one first message may be used to indicate one of the foregoing operation types. This is not limited in embodiments of this application. With reference to indication manners 1 to 3, the following describes indication of the foregoing plurality of operation types by using the first message.

In an indication manner 1, the first message includes a plurality of indicator fields, and different indicator fields in the plurality of indicator fields are associated with different operation types of data collection task management operations.

That different indicator fields are associated with different operation types may be understood that the different indicator fields are used to carry information (for example, a task identity of a data collection task and/or a data type identity) required for corresponding operation types. For specific information carried in different indicator fields, refer to the foregoing descriptions. For brevity, details are not described again below.

In embodiments of this application, an association relationship between an indicator field and an operation type may be preconfigured, predefined, or configured by a network device. This is not limited in embodiments of this application.

For example, the plurality of indicator fields of the first message include an indicator field 1, an indicator field 2, and an indicator field 3, and a plurality of data collection task management operations include adding a data collection task, deleting a data collection task, and suspending a data collection task. Correspondingly, the indicator field 1 may be associated with adding a data collection task, the indicator field 2 may be associated with deleting a data collection task, and the indicator field 3 may be associated with suspending a data collection task.

For another example, the plurality of indicator fields of the first message include an indicator field 1 and an indicator field 2, and a plurality of data collection task management operations include suspending a data collection task and resuming a data collection task. Correspondingly, the indicator field 1 may be associated with suspending a data collection task, and the indicator field 2 may be associated with resuming a data collection task. In this case, the suspended data collection task and the resumed data collection task may be different.

In an indication manner 2, the first message includes a plurality of message types, and different message types in the plurality of message types are associated with different operation types of data collection task management operations.

That different message types are associated with different operation types may be understood that the first messages corresponding to the different message types is used to carry information (for example, a task identity of a data collection task and/or a data type identity) required for corresponding operation types. For specific information carried in the first messages of different message types, refer to the foregoing descriptions. For brevity, details are not described again below.

In embodiments of this application, an association relationship between a message type and an operation type may be preconfigured, predefined, or configured by a network device. This is not limited in embodiments of this application.

For example, the plurality of message types of the first message include a message type 1, a message type 2, and a message type 3, and a plurality of data collection task management operations include adding a data collection task, deleting a data collection task, and suspending a data collection task. Correspondingly, the message type 1 may be associated with adding a data collection task, the message type 2 may be associated with deleting a data collection task, and the message type 3 may be associated with suspending a data collection task.

In some scenarios, the foregoing data collection task management operation may apply to a specific range. For example, the data collection task management operation applies to one or more of a cell, a protocol layer, a bandwidth part (BWP), or a transmission configuration indicator (TCI). In some implementations, the first message may carry identity information to indicate a range to which the data collection task management operation applies. For example, the first message may include one or more of cell identity information, protocol layer identity information, BWP identity information, or TCI identity information associated with the data collection task management operation.

In embodiments of this application, a protocol layer indicated by the protocol layer identity information is not limited. In some implementations, the protocol layer indicated by the protocol layer identity information may include one or more of a non-access stratum (NAS) layer, a service data adaptation protocol (SDAP) layer, a radio resource control (RRC) layer, a packet data convergence protocol (PDCP) layer, a radio link control (RLC) layer, a backhaul adaptation protocol (BAP) layer, a media access control (MAC) layer, or a physical (PHY) layer. In some embodiments of this application, the protocol layer may further include a protocol layer newly introduced in a future communications protocol.

Taking the indication manner 1 as an example, the identity information indicating the range to which the data collection task management operation applies may be carried in an indicator field associated with the data collection task management operation. In some embodiments of this application, the identity information indicating the range to which the data collection task management operation applies may be alternatively carried in a dedicated indicator field. This is not limited in embodiments of this application.

For example, the data collection task management operation is suspending a data collection task, and the indicator field 1 in the first message is associated with suspending a data collection task. In this case, the indicator field 1 may carry a task identity of the suspended data collection task and cell identity information associated with the suspended data collection task.

For another example, the data collection task management operation is resuming a data collection task, and the indicator field 2 in the first message is associated with resuming a data collection task. In this case, the indicator field 2 may carry a task identity of the resumed data collection task and BWP identity information associated with the resumed data collection task.

In some embodiments of this application, the identity information indicating the range to which the data collection task management operation applies may be alternatively used to add a data collection task, modify a data collection task, or delete a data collection task. This is not limited in this application.

### Scenario 4: Scenario of Transmitting a Capability of Collecting Data.

In some scenarios, information of respective capabilities of collecting data (also referred to as “data collection capabilities”) need to be exchanged between devices, thereby improving data acquisition efficiency. In this case, the first device may notify, by using the first message, the second device of a capability related to collecting data. The following uses the first data as an example for description. In other words, the first message includes a capability related to collecting the first data by the first device.

In some implementations, the capability related to collecting the first data by the first device includes one or more of the following information: a data type identity of the first data that the first device supports collecting; a collection condition associated with the first data that the first device supports collecting; a data type identity associated with the first data that the first device does not support to collect; or a collection barring condition associated with the first data that the first device does not support to collect.

In an example in which the capability related to collecting the first data includes the data type identity of the first data that the first device supports collecting, the first data may be of a type being one of a plurality of types of data that the first device supports collecting. In some embodiments of this application, the first device may support collection of only a data type of the first data. This is not limited in embodiments of this application.

In an example in which the capability related to collecting the first data includes the collection condition associated with the first data that the first device supports collecting, the collection condition is used to indicate a condition met when collecting the first data, or in other words, the first data can be collected in a case that the collection condition is met. Otherwise, the first data cannot be collected in a case that the collection condition is not met.

For example, at present, a beam is used in high-frequency communication. If the first data is associated with a beam, the collection condition associated with the first data may include being in a high-frequency scenario. That is, data associated with a beam is collected in a high-frequency scenario. Otherwise, data associated with a beam is not collected in a non-high-frequency scenario.

In an example in which the capability related to collecting the first data includes the data type identity associated with the first data that the first device does not support to collect, the first data may be one of a plurality of types of data that the first device does not support to collect. In some embodiments of this application, the first device may not support collection of only a data type of the first data. This is not limited in embodiments of this application.

In an example in which the capability related to collecting the first data includes the collection barring condition associated with the first data that the first device does not support collecting, the collection barring condition is used to indicate a condition met when not collecting the first data, or in other words, the first data is not collected in a case that the collection barring condition is met. Otherwise, the first data may be collected in a case that the collection barring condition is not met.

For example, at present, a beam is used in high-frequency communication. If the first data is associated with a beam, the collection barring condition associated with the first data may include being in a low-frequency scenario. That is, data associated with a beam is not collected in a low-frequency scenario. Otherwise, data associated with a beam may be collected in a non-low-frequency scenario.

In some scenarios, for different granularities (for example, one or more of a protocol layer identity granularity, an AI model identity granularity, a function characteristic granularity, a band granularity, or a band combination granularity), capabilities of collecting data of a same data type by the first device may be different. Therefore, in embodiments of this application, the capability related to collecting the first data by the first device is indicated for different granularities. In other words, one or more types of the capability related to collecting the first data by the first device may be provided based on one or more of the following granularities: a protocol layer identity granularity, an AI model identity granularity, a function characteristic granularity, a band granularity, or a band combination granularity.

In some implementations, the first message may include a granularity associated with a capability of collecting data of a data type by the first device. In some embodiments of this application, if capabilities of collecting data of a same data type by the first device are the same for different granularities, the first message may alternatively not include a granularity associated with a capability of collecting data of a data type by the first device.

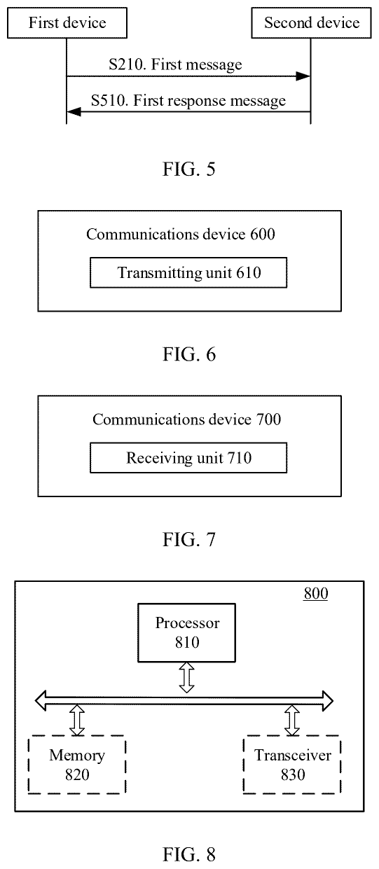

As described above, to enable devices to know respective data collection capabilities, the second device may transmit a first response message to the first device, to indicate a capability related to collecting data by the second device. As shown in FIG. 5, the foregoing method further includes step S510. In step S510, the second device transmits a first response message to the first device in response to the first message, where the first response message includes a capability related to collecting data by the second device. In some embodiments of this application, the second device may actively indicate the capability related to collecting data by the second device to the first device. This is not limited in embodiments of this application.

In some implementations, the capability related to collecting data by the second device includes one or more of the following information: a data type identity of data that the second device supports collecting; a collection condition associated with data that the second device supports collecting; a data type identity associated with data that the second device does not support to collect; or a collection barring condition associated with data that the second device does not support to collect.

In an example in which the capability related to collecting data includes the data type identity associated with the data that the second device supports collecting, the data that the second device supports collecting may include one or more types.

In an example in which the capability related to collecting data includes the collection condition associated with the data that the second device supports collecting, the collection condition is used to indicate a condition met when collecting data, or in other words, data can be collected in a case that the collection condition is met. Otherwise, data cannot be collected in a case that the collection condition is not met.

For example, at present, a beam is used in high-frequency communication. If data is associated with a beam, a collection condition associated with the data may include being in a high-frequency scenario. That is, data associated with a beam is collected in a high-frequency scenario. Otherwise, data associated with a beam is not collected in a non-high-frequency scenario.

In an example in which the capability related to collecting data includes the data type identity associated with the data that the second device does not support to collect, the data that the second device does not support to collect may include one or more types.

In an example in which the capability related to collecting data includes the collection barring condition associated with data that the second device does not support to collect, the collection barring condition is used to indicate a condition met when not collecting data, or in other words, data is not collected in a case that the collection barring condition is met. Otherwise, data may be collected in a case that the collection barring condition is not met.

For example, at present, a beam is used in high-frequency communication. If data is associated with a beam, a collection barring condition associated with the data may include being in a low-frequency scenario. That is, data associated with a beam is not collected in a low-frequency scenario. Otherwise, data associated with a beam may be collected in a non-low-frequency scenario.

In some scenarios, for different granularities (for example, one or more of a protocol layer identity granularity, an AI model identity granularity, a function characteristic granularity, a band granularity, or a band combination granularity), capabilities of collecting data of a same data type by the second device may be different. Therefore, in embodiments of this application, the capability related to collecting data by the second device is indicated for different granularities. In other words, one or more of the data collection-related capabilities of the second device may be provided based on one or more of the following granularities: a protocol layer identity granularity, an AI model identity granularity, a function characteristic granularity, a band granularity, or a band combination granularity.

In some implementations, the first response message may include a granularity associated with a capability of collecting data of a data type by the second device. In some embodiments of this application, if capabilities of collecting data of a same data type by the second device are the same for different granularities, the first response message may alternatively not include a granularity associated with a capability of collecting data of a data type by the second device.

In embodiments of this application, a manner of transmitting the message described above (for example, one or more of the first message, the second message, the third message, or the first response message) is not limited. In other words, some or all of the foregoing messages may be any one of a unicast message, a multicast message, or a broadcast message.

The unicast message may be understood as a unicast message transmitted by an information source through a unicast channel. Generally, only a device (for example, a terminal device) allocated with a corresponding unicast resource can attempt to receive the unicast message. In some scenarios, the unicast message may also be referred to as dedicated signalling.

The multicast message may be understood as a multicast message transmitted by an information source through a multicast channel, and one or more devices located in the coverage of a multicast signal and belonging to members of a group may attempt to receive the multicast message. Generally, a device obtains a multicast channel-related resource when joining a communications group.

The broadcast message may be understood as a broadcast message transmitted by an information source through a broadcast channel. Correspondingly, any device within coverage of a broadcast signal may attempt to receive the broadcast message.

In addition, a type of the message described above is not limited in embodiments of this application. In some implementations, some or all of the foregoing messages may be any one of the following message types: a NAS message, an RRC message, a MAC control element (MAC CE), downlink control information (DCI), uplink control information (UCI), a physical uplink shared channel (PUSCH), an inter-node message, an Xn message, an F1 message, an E1 message, an NG message, or a core network bus message.

The method embodiments of this application are described above in detail with reference to FIG. 1 to FIG. 5. Apparatus embodiments of this application are described below in detail with reference to FIG. 6 to FIG. 8. It should be understood that the descriptions of the method embodiments correspond to descriptions of the apparatus embodiments, and therefore, for parts that are not described in detail, reference may be made to the foregoing method embodiments.

FIG. 6 is a schematic diagram of a communications device according to an embodiment of this application. The communications device 600 shown in FIG. 6 is a first device and includes a transmitting unit 610.

The transmitting unit 610 is configured to transmit a first message to a second device, where the first message is used for management and control related to first data, and the first message is associated with a data type identity of the first data.

In some implementations, if the first message is associated with the data type identity of the first data, the data type identity of the first data is associated with data feature information of the first data, and the data feature information of the first data includes one or more of the following: a data meaning of the first data; a data source of the first data; or data precision of the first data.

In some implementations, if the data feature information of the first data includes the data source of the first data, the data source of the first data is used to indicate one or more of the following: a country to which the first data belongs; a geographical area to which the first data belongs; an operator to which the first data belongs; a cell to which the first data belongs; a tracking area to which the first data belongs; or an access network notification area to which the first data belongs.

In some implementations, the data type identity of the first data is carried in a first indicator field in the first message, and the first indicator field is associated with one or more types of the data feature information of the first data.

In some implementations, the first indicator field is one of a plurality of indicator fields in the first message that carry the data type identity of the first data, the plurality of indicator fields further include at least one second indicator field, and each of the at least one second indicator field is associated with respective one or more types of the data feature information of the first data.

In some implementations, the data feature information of the first data associated with the first indicator field is partially or entirely different from the data feature information of the first data associated with any one of the at least one second indicator field.

In some implementations, the data type identity of the first data includes a plurality of type identities, and the plurality of type identities include one or more of the following: a globally unique data type identity; an area-defined data type identity; or a temporary data type identity.

In some implementations, the first message is used to indicate an association relationship between the plurality of type identities, and the association relationship includes one or more of the following: the plurality of type identities are in a one-to-one association relationship; the plurality of type identities are in a many-to-one association relationship; or the plurality of type identities are in a one-to-many association relationship.

In some implementations, the communications device further includes: a first receiving unit, configured to receive a second message transmitted by the second device, where the second message is used to request the association relationship or is used to trigger transmission of the first message.

In some implementations, the first message is used to indicate a transmission state of the first data, and if the first data belongs to a data type that the first device is concerned with, the first message includes one or more of the following information: data type identity information associated with data providable by the first device; data volume information associated with data providable by the first device; precision information associated with data providable by the first device; data source information associated with data providable by the first device; data type identity information associated with data that is not providable by the first device; cause indication information associated with data that is not providable by the first device; or restriction condition information associated with data that is not providable by the first device.

In some implementations, if the first message includes the cause indication information associated with the data that is not providable by the first device, the cause indication information is used to indicate one or more of the following: the first device does not support collection of the data that is not providable; the first device supports collection of the data that is not providable, and a current data volume of the data that is not providable is 0; the first device supports collection of the data that is not providable, and a current data volume of the data that is not providable is less than a preset data volume; the first device supports collection of the data that is not providable, and a current data volume of the data that is not providable is less than a data volume required by a data requester; or the data that is not providable by the first device does not meet the associated restriction condition or meets the associated restriction condition.

In some implementations, the restriction condition information includes one or more of the following information: first time information, where data associated with the first time information is providable outside a range constrained by the first time information or within a range constrained by the first time information; second time information, where data associated with the second time information is not providable outside a range constrained by the second time information or within a range constrained by the second time information; first logical area information, where data associated with the first logical area information is providable outside a range constrained by the first logical area information or within a range constrained by the first logical area information; or second logical area information, where data associated with the second logical area information is not providable outside a range constrained by the second logical area information or within a range constrained by the second logical area information.

In some implementations, at least one of the first logical area information or the second logical area information includes one or more of the following information: public land mobile network PLMN identity information, cell identity information, tracking area code TAC identity information, or access network notification area RANAC identity information.

In some implementations, the communications device further includes: a second receiving unit, configured to receive a third message transmitted by the second device, where the third message is used to request to query the transmission state of the first data.

In some implementations, the third message includes one or more of the following: data type identity information associated with the first data; data volume requirement information associated with the first data; data source requirement information associated with the first data; or precision requirement information associated with the first data.

In some implementations, the first message is used to execute a data collection task management operation, and the data collection task management operation is associated with the first data.

In some implementations, the data collection task management operation includes one or more of the following operations: adding a data collection task; deleting a data collection task; modifying a data collection task; suspending a data collection task; or resuming a data collection task.

In some implementations, message types of the first message used for different operations in the data collection task management operation are the same or different.

In some implementations, the first message includes the data type identity of the first data and/or an identity of the data collection task, and there is an association relationship between the identity of the data collection task and the data type identity of the first data.

In some implementations, the identity of the data collection task and the data type identity of the first data are in a one-to-one association relationship; or the identity of the data collection task and the data type identity of the first data are in a one-to-many association relationship.

In some implementations, the first message further includes one or more of cell identity information, protocol layer identity information, bandwidth part BWP identity information, or transmission configuration indicator TCI identity information associated with the data collection task management operation.

In some implementations, the first message includes a capability related to collecting the first data by the first device.

In some implementations, the capability related to collecting the first data by the first device includes one or more of the following information: a data type identity of the first data that the first device supports collecting; a collection condition associated with the first data that the first device supports collecting; a data type identity associated with the first data that the first device does not support to collect; or a collection barring condition associated with the first data that the first device does not support to collect.

In some implementations, one or more types of the capability related to collecting the first data by the first device is provided based on one or more of the following granularities: a protocol layer identity granularity, an AI model identity granularity, a function characteristic granularity, a band granularity, or a band combination granularity.

In some implementations, the communications device further includes: a third receiving unit, configured to: receive a first response message transmitted by the second device in response to the first message, where the first response message includes a capability related to collecting data by the second device.

In some implementations, the capability related to collecting data by the second device includes one or more of the following information: a data type identity of data that the second device supports collecting; a collection condition associated with data that the second device supports collecting; a data type identity associated with data that the second device does not support to collect; or a collection barring condition associated with data that the second device does not support to collect.

In some implementations, one or more types of the capability related to collecting data by the second device is provided based on one or more of the following granularities: a protocol layer identity granularity, an AI model identity granularity, a function characteristic granularity, a band granularity, or a band combination granularity.

In some implementations, the first message is any one of the following message types: a multicast message, a broadcast message, or a unicast message.

In some implementations, the first device and the second device meet one of the following: the first device is a terminal device, and the second device is a network device; the first device is a network device, and the second device is a terminal device; both the first device and the second device are network devices; or both the first device and the second device are terminal devices.

FIG. 7 is a schematic diagram of a communications device according to an embodiment of this application. The communications device shown in FIG. 7 is a second device and includes a receiving unit 710.

The receiving unit 710 is configured to receive a first message transmitted by a first device, where the first message is used for management and control related to first data, and the first message is associated with a data type identity of the first data.

In some implementations, if the first message is associated with the data type identity of the first data, the data type identity of the first data is associated with data feature information of the first data, and the data feature information of the first data includes one or more of the following: a data meaning of the first data; a data source of the first data; or data precision of the first data.

In some implementations, if the data feature information of the first data includes the data source of the first data, the data source of the first data is used to indicate one or more of the following: a country to which the first data belongs; a geographical area to which the first data belongs; an operator to which the first data belongs; a cell to which the first data belongs; a tracking area TAC to which the first data belongs; or an access network notification area to which the first data belongs.

In some implementations, the data type identity of the first data is carried in a first indicator field in the first message, and the first indicator field is associated with one or more types of the data feature information of the first data.

In some implementations, the first indicator field is one of a plurality of indicator fields in the first message that carry the data type identity of the first data, the plurality of indicator fields further include at least one second indicator field, and each of the at least one second indicator field is associated with respective one or more types of the data feature information of the first data.

In some implementations, the data feature information of the first data associated with the first indicator field is partially or entirely different from the data feature information of the first data associated with any one of the at least one second indicator field.

In some implementations, the data type identity of the first data includes a plurality of type identities, and the plurality of type identities include one or more of the following: a globally unique data type identity; an area-defined data type identity; or a temporary data type identity.

In some implementations, the first message is used to indicate an association relationship between the plurality of type identities, and the association relationship includes one or more of the following: the plurality of type identities are in a one-to-one association relationship; the plurality of type identities are in a many-to-one association relationship; or the plurality of type identities are in a one-to-many association relationship.

In some implementations, the communications device further includes: a first transmitting unit, configured to transmit a second message to the first device, where the second message is used to request the association relationship or is used to trigger transmission of the first message.

In some implementations, the first message is used to indicate a transmission state of the first data, and if the first data belongs to a data type that the first device is concerned with, the first message includes one or more of the following information: data type identity information associated with data providable by the first device; data volume information associated with data providable by the first device; precision information associated with data providable by the first device; data source information associated with data providable by the first device; data type identity information associated with data that is not providable by the first device; cause indication information associated with data that is not providable by the first device; or restriction condition information associated with data that is not providable by the first device.

In some implementations, if the first message includes the cause indication information associated with the data that is not providable by the first device, the cause indication information is used to indicate one or more of the following: the first device does not support collection of the data that is not providable; the first device supports collection of the data that is not providable, and a current data volume of the data that is not providable is 0; the first device supports collection of the data that is not providable, and a current data volume of the data that is not providable is less than a preset data volume; the first device supports collection of the data that is not providable, and a current data volume of the data that is not providable is less than a data volume required by a data requester; or the data that is not providable by the first device does not meet the associated restriction condition or meets the associated restriction condition.

In some implementations, the restriction condition information includes one or more of the following information: first time information, where data associated with the first time information is providable outside a range constrained by the first time information or within a range constrained by the first time information; second time information, where data associated with the second time information is not providable outside a range constrained by the second time information or within a range constrained by the second time information; first logical area information, where data associated with the first logical area information is providable outside a range constrained by the first logical area information or within a range constrained by the first logical area information; or second logical area information, where data associated with the second logical area information is not providable outside a range constrained by the second logical area information or within a range constrained by the second logical area information.

In some implementations, at least one of the first logical area information or the second logical area information includes one or more of the following information: public land mobile network PLMN identity information, cell identity information, tracking area code TAC identity information, or access network notification area RANAC identity information.

In some implementations, the communications device further includes: a second transmitting unit, configured to transmit a third message to the first device, where the third message is used to request to query the transmission state of the first data.

In some implementations, the third message includes one or more of the following: data type identity information associated with the first data; data volume requirement information associated with the first data; data source requirement information associated with the first data; or precision requirement information associated with the first data.

In some implementations, the first message is used to execute a data collection task management operation, and the data collection task management operation is associated with the first data.

In some implementations, the data collection task management operation includes one or more of the following operations: adding a data collection task; deleting a data collection task; modifying a data collection task; suspending a data collection task; or resuming a data collection task.

In some implementations, message types of the first message used for different operations in the data collection task management operation are the same or different.

In some implementations, the first message includes the data type identity of the first data and/or an identity of the data collection task, and there is an association relationship between the identity of the data collection task and the data type identity of the first data.

In some implementations, the identity of the data collection task and the data type identity of the first data are in a one-to-one association relationship; or the identity of the data collection task and the data type identity of the first data are in a one-to-many association relationship.

In some implementations, the first message further includes one or more of cell identity information, protocol layer identity information, bandwidth part BWP identity information, or transmission configuration indicator TCI identity information associated with the data collection task management operation.

In some implementations, the first message includes a capability related to collecting the first data by the first device.

In some implementations, the capability related to collecting the first data by the first device includes one or more of the following information: a data type identity of the first data that the first device supports collecting; a collection condition associated with the first data that the first device supports collecting; a data type identity associated with the first data that the first device does not support to collect; or a collection barring condition associated with the first data that the first device does not support to collect.

In some implementations, one or more types of the capability related to collecting the first data by the first device is provided based on one or more of the following granularities: a protocol layer identity granularity, an AI model identity granularity, a function characteristic granularity, a band granularity, or a band combination granularity.

In some implementations, the communications device further includes: a third transmitting unit, configured to transmit a first response message to the first device in response to the first message, where the first response message includes a capability related to collecting data by the second device.

In some implementations, the capability related to collecting data by the second device includes one or more of the following information: a data type identity of data that the second device supports collecting; a collection condition associated with data that the second device supports collecting; a data type identity associated with data that the second device does not support to collect; or a collection barring condition associated with data that the second device does not support to collect.

In some implementations, one or more types of the capability related to collecting data by the second device is provided based on one or more of the following granularities: a protocol layer identity granularity, an AI model identity granularity, a function characteristic granularity, a band granularity, or a band combination granularity.

In some implementations, the first message is any one of the following message types: a multicast message, a broadcast message, or a unicast message.

In some implementations, the first device and the second device meet one of the following: the first device is a terminal device, and the second device is a network device; the first device is a network device, and the second device is a terminal device; both the first device and the second device are network devices; or both the first device and the second device are terminal devices.

In an optional embodiment, the transmitting unit 610 may be a transceiver 830. A communications device 800 may further include a processor 810 and a memory 820, which are specifically shown in FIG. 8.

In an optional embodiment, the receiving unit 710 may be a transceiver 830. A communications device 800 may further include a processor 810 and a memory 820, which are specifically shown in FIG. 8.

FIG. 8 is a schematic structural diagram of a communications device according to an embodiment of this application. Dashed lines in FIG. 8 indicate that a unit or module is optional. The apparatus 800 may be configured to implement a method described in the foregoing method embodiments. The apparatus 800 may be a chip, a terminal device, or a network device.

The apparatus 800 may include one or more processors 810. The processor 810 may support the apparatus 800 in implementing a method described in the foregoing method embodiments. The processor 810 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 800 may further include one or more memories 820. The memory 820 stores a program that may be executed by the processor 810 to cause the processor 810 to execute a method described in the foregoing method embodiments. The memory 820 may be separate from the processor 810 or may be integrated into the processor 810.

The apparatus 800 may further include a transceiver 830. The processor 810 may communicate with another device or chip through the transceiver 830. For example, the processor 810 may transmit data to and receive data from another device or chip through the transceiver 830.

An embodiment of this application further provides a computer-readable storage medium, configured to store a program. The computer-readable storage medium may be applied to a terminal or a network device provided in embodiments of this application, and the program causes a computer to execute a method executed by the terminal or the network device in embodiments of this application.

An embodiment of this application further provides a computer program product. The computer program product includes a program. The computer program product may be applied to a terminal or a network device provided in embodiments of this application, and the program causes a computer to execute a method executed by the terminal or the network device in embodiments of this application.

An embodiment of this application further provides a computer program. The computer program may be applied to a terminal or a network device provided in embodiments of this application, and the computer program causes a computer to execute a method executed by the terminal or the network device in embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “preconfigured” may be implemented by prestoring corresponding code, tables, or other forms that may be used to indicate related information in devices (for example, including a terminal device and a network device), and a specific implementation thereof is not limited in this application. For example, being predefined may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between associated objects.

In embodiments of this application, sequence numbers of the foregoing processes do not mean execution sequences. The execution sequences of the processes should be determined according to functions and internal logic of the processes, and should not be construed as any limitation on implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, all or some of the foregoing embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A first device, comprising a transceiver, a memory, and a processor, wherein the memory is configured to store a program, and the processor is configured to invoke the program in the memory and control the transceiver to receive or transmit a signal, to cause the first device to:
transmit a first message to a second device, wherein the first message is used for management and control related to first data, and the first message is associated with a data type identity of the first data.

2. The first device according to claim 1, wherein if the first message is associated with the data type identity of the first data, the data type identity of the first data is associated with data feature information of the first data, and the data feature information of the first data comprises one or more of following:
a data meaning of the first data;
a data source of the first data; or
data precision of the first data.

3. The first device according to claim 2, wherein if the data feature information of the first data comprises the data source of the first data, the data source of the first data is used to indicate one or more of following:
a country to which the first data belongs;
a geographical area to which the first data belongs;
an operator to which the first data belongs;
a cell to which the first data belongs;
a tracking area to which the first data belongs; or
an access network notification area to which the first data belongs.

4. The first device according to claim 1, wherein the data type identity of the first data is carried in a first indicator field in the first message, and the first indicator field is associated with one or more types of the data feature information of the first data.

5. The first device according to claim 4, wherein the first indicator field is one of a plurality of indicator fields in the first message that carry the data type identity of the first data, the plurality of indicator fields further comprise at least one second indicator field, and each of the at least one second indicator field is associated with respective one or more types of the data feature information of the first data.

6. The first device according to claim 5, wherein the data feature information of the first data associated with the first indicator field is partially or entirely different from the data feature information of the first data associated with any one of the at least one second indicator field.

7. The first device according to claim 1, wherein the data type identity of the first data comprises a plurality of type identities, and the plurality of type identities comprise one or more of following:
a globally unique data type identity;
an area-defined data type identity; or
a temporary data type identity.

8. The first device according to claim 7, wherein the first message is used to indicate an association relationship between the plurality of type identities, and the association relationship comprises one or more of following:
the plurality of type identities are in a one-to-one association relationship;
the plurality of type identities are in a many-to-one association relationship; or
the plurality of type identities are in a one-to-many association relationship.

9. The first device according to claim 8, wherein the processor is configured to invoke the program in the memory and control the transceiver to receive or transmit a signal, to cause the first device further to:
receive a second message transmitted by the second device, wherein the second message is used to request the association relationship or is used to trigger transmission of the first message.

10. A second device, comprising a transceiver, a memory, and a processor, wherein the memory is configured to store a program, and the processor is configured to invoke the program in the memory and control the transceiver to receive or transmit a signal, to cause the second device to:
receive a first message transmitted by a first device, wherein the first message is used for management and control related to first data, and the first message is associated with a data type identity of the first data.

11. The second device according to claim 10, wherein the first message is used to indicate a transmission state of the first data, and if the first data belongs to a data type that the first device is concerned with, the first message comprises one or more of following information:
data type identity information associated with data providable by the first device;
data volume information associated with data providable by the first device;
precision information associated with data providable by the first device;
data source information associated with data providable by the first device;
data type identity information associated with data that is not providable by the first device;
cause indication information associated with data that is not providable by the first device; or
restriction condition information associated with data that is not providable by the first device.

12. The second device according to claim 11, wherein if the first message comprises the cause indication information associated with the data that is not providable by the first device, the cause indication information is used to indicate one or more of following:
the first device does not support collection of the data that is not providable;
the first device supports collection of the data that is not providable, and a current data volume of the data that is not providable is 0;
the first device supports collection of the data that is not providable, and a current data volume of the data that is not providable is less than a preset data volume;
the first device supports collection of the data that is not providable, and a current data volume of the data that is not providable is less than a data volume required by a data requester; or
the data that is not providable by the first device does not meet the associated restriction condition or meets the associated restriction condition.

13. The second device according to claim 11, wherein the restriction condition information comprises one or more of following information:
first time information, wherein data associated with the first time information is providable outside a range constrained by the first time information or within a range constrained by the first time information;
second time information, wherein data associated with the second time information is not providable outside a range constrained by the second time information or within a range constrained by the second time information;
first logical area information, wherein data associated with the first logical area information is providable outside a range constrained by the first logical area information or within a range constrained by the first logical area information; or
second logical area information, wherein data associated with the second logical area information is not providable outside a range constrained by the second logical area information or within a range constrained by the second logical area information.

14. The second device according to claim 13, wherein at least one of the first logical area information or the second logical area information comprises one or more of following information:
public land mobile network (PLMN) identity information, cell identity information, tracking area code (TAC) identity information, or access network notification area (RANAC) identity information.

15. The second device according to claim 11, wherein the processor is configured to invoke the program in the memory and control the transceiver to receive or transmit a signal, to cause the second device further to:
transmit a third message to the first device, wherein the third message is used to request to query the transmission state of the first data;
wherein the third message comprises one or more of following information:
data type identity information associated with the first data;
data volume requirement information associated with the first data;
data source requirement information associated with the first data; or
precision requirement information associated with the first data.

16. The second device according to claim 10, wherein the first message is used to execute a data collection task management operation, and the data collection task management operation is associated with the first data;
wherein the data collection task management operation comprises one or more of following operations:
adding a data collection task;
deleting a data collection task;
modifying a data collection task;
suspending a data collection task; or
resuming a data collection task,
wherein the first message comprises the data type identity of the first data and/or an identity of the data collection task, and there is an association relationship between the identity of the data collection task and the data type identity of the first data.

17. The second device according to claim 16, wherein the first message further comprises one or more of cell identity information, protocol layer identity information, bandwidth part (BWP) identity information, or transmission configuration indicator (TCI) identity information associated with the data collection task management operation.

18. The second device according to claim 10, wherein the first message comprises a capability related to collecting the first data by the first device,
wherein the capability related to collecting the first data by the first device comprises one or more of following information:
a data type identity of the first data that the first device supports collecting;
a collection condition associated with the first data that the first device supports collecting;
a data type identity associated with the first data that the first device does not support to collect; or
a collection barring condition associated with the first data that the first device does not support to collect,
wherein one or more types of the capability related to collecting the first data by the first device is provided based on one or more of following granularities: a protocol layer identity granularity, an AI model identity granularity, a function characteristic granularity, a band granularity, or a band combination granularity.

19. The second device according to claim 18, wherein the processor is configured to invoke the program in the memory and control the transceiver to receive or transmit a signal, to cause the second device further to:
transmit a first response message to the first device in response to the first message, wherein the first response message comprises a capability related to collecting data by the second device;
wherein the capability related to collecting data by the second device comprises one or more of following information:
a data type identity of data that the second device supports collecting;
a collection condition associated with data that the second device supports collecting;
a data type identity associated with data that the second device does not support to collect; or
a collection barring condition associated with data that the second device does not support to collect;
wherein one or more types of the capability related to collecting data by the second device is provided based on one or more of following granularities: a protocol layer identity granularity, an AI model identity granularity, a function characteristic granularity, a band granularity, or a band combination granularity.

20. A wireless communication method, comprising:
transmitting, by a first device, a first message to a second device, wherein the first message is used for management and control related to first data, and the first message is associated with a data type identity of the first data.
